(19) United States
(12) Patent Application Publication
(10) Pub. No.: US 2014/0279694 A1
(43) Pub. Date: Sep. 18, 2014

(54) METHOD AND DEVICE FOR FACILITATING FINANCING FOR PROJECTS

(71) Applicant: RePower Captial, Inc., Sausalito, CA (US)

(72) Inventors: Derek K. Gauger, San Diego, CA (US); Wayne Van Dyck, Sausalito, CA (US)

(73) Assignee: RePower Captial, Inc., Sausalito, CA (US)

(21) Appl. No.: 14/211,085

(22) Filed: Mar. 14, 2014

Related U.S. Application Data
(60) Provisional application No. 61/787,278, filed on Mar. 15, 2013.

(51) Int. Cl. G06Q 40/06

(52) U.S. Cl. CPC G06Q 40/06
USPC 705/36 R

(57) ABSTRACT

A method and apparatus for facilitating a financing process for clean energy and other projects employing software, process automation, project management, electronic communications, a pre-screening means, a vetting means, a project to investor matching means, and a due diligence system.

### CROSS REFERENCE TO CO-PENDING APPLICATION

Applicants claim priority benefit to the Mar. 15, 2013 filing date of co-pending U.S. Provisional Patent Application Ser. 61/787,278 for a Method and Device For Facilitating Financing For Products, the entire contents of which are incorporate herein by reference.

### BACKGROUND

The present method and device relates to the process of project finance.

Presently, there exists a global need in industry, both private and public, for streamlining and making more efficient the process of project finance, particularly in the field of clean energy installations. Firstly, there are disconnects between the style of language and financial analysis formatting that typical project developers use and those that investors are accustomed to. Secondly, most project developers do not understand all of the factors that investors use to evaluate a potential investment. Thirdly, most investors do not consider even looking at investments under a certain threshold not due to these investments being unviable; but simply because of the sheer volume of them coming to the investors one by one instead of in some organized fashion. This leaves many viable projects without funding sources. Fourthly, the end-to-end process for completing a project financing is highly labor intensive. This makes the process very inefficient and typically leads to many fundable projects failing to achieve financing. Fifthly, organization, control, and standardization of all of the data types related to project financings is currently handled in an ad hoc arrangement which leaves many opportunities for error and misunderstanding.

The present method solves these issues and others relating to improving the field of project financing. The present method will enable, enhance, and automate project finance for clean energy projects ready for either development or construction.

Currently, access to capital for project developers is difficult. If the project is under a certain threshold or is for a clean energy project, developers have few conduits to evaluate their projects to investor's preferences and have no opportunities to do this in an automated or online format. This product uses software and Internet technologies to provide developers and investors the ability to evaluate projects in a structured and automated regimen that increases the project developer's access to capital and dramatically decreases the overall time to do so.

### SUMMARY

A method and apparatus that streamlines the process of project financing. The apparatus may be a typical client server arrangement or an Internet enabled device typically referred to software as a service where the software is hosted by a central server or distributed servers. Project developers input data and information about their “to be financed” project to the system. This information includes, but is not limited to financial analysis, geographical information, project type, technology being utilized, buyers and agreements related to the project outputs, licenses, power purchase agreements, interconnection agreements, etc. Potential financing sources and companies input information on their current finance preferences for their desired projects. This information includes but is not limited to, geographic preferences, technology preferences, return on investment targets, project size, financed amount, technical readiness, launch readiness, overall risk identifiers, specific risk identifiers, etc.

The method and apparatus first automatically pre-screens projects that are uploaded to the system through the application of algorithms and financial analyses and factor-based criteria. If a project does not pass a pre-screening, the project developer automatically receives information about what areas of improvement are needed to produce a fundable project along with metrics related to how many investors may be interested if the project leaders improve their project in the manner suggested. If a project passes the pre-screening, the system subjects it to a higher level vetting analysis. This includes but is not limited to a full financial analysis, a data room where the project developer uploads pertinent documents for due diligence, an initiation of a project risk analysis system with graphical representation, a more qualified list of potential investors, etc.

The method and apparatus continuously performs matching between project profiles and investor profiles. When the information and analyses of a project are complete enough and fit any particular investor's or group of investor's criteria, the system automatically generates a series of reports for automatic or manual forced communication with the qualified investors. During this stage, a project management system automatically controls, guides, and controls the communication between the system, project developers, and investors until a financing is complete.

### BRIEF DESCRIPTION OF THE DRAWINGS

The description herein makes reference to the accompanying drawings wherein like reference numerals refer to like parts throughout the several views, and wherein:

FIG. 1 is a flow chart of the overall apparatus depicting the generic interaction between the various users of the software system.

FIG. 2 is a diagram showing the modules within the apparatus related to various types of projects.

FIG. 3 is a flow chart showing the high-level steps employed in the method and apparatus.

FIG. 4 is a diagram outlining the high-level functionalities of the method and apparatus;

FIG. 5 is a diagram outlining the process flow for a request for change in a serial process in the method and apparatus;

FIG. 6 is a diagram outlining the process flow for a request for change in a parallel process in the method and apparatus;

FIG. 7 is a diagram outlining the process flow for a request for information in the method and apparatus;

FIG. 8 is a diagram outlining the process flow for a request for review with a parallel process in the method and apparatus.

FIG. 9 is a diagram outlining the process flow for a request for review with a series process in the software system.

### DETAILED DESCRIPTION

FIG. 1 shows a high-level depiction of the communication that occurs during the usage of the method and apparatus. The apparatus 2 and process 1 enables communication bidirectionally with project developers, leaders, initiators, managers, executives, or other term representing substantially the same meaning herein referred to as project leaders 3. These project leaders 3 are associated with one or more than one individual projects or sub-projects depicted by projects A through Z. This depiction is random as each individual project may be represented by many different means including names, code numbers, etc and may be any number one or greater in quantity and are not limited to the arbitrary representation of 26 letters of the alphabet in FIG. 1.

The communication between the project leaders 3 and the apparatus 2 takes place primarily electronically but is not limited to electronic communication. The electronic communication can take place through an Internet enabled connection between the project leaders 3 computers and the server or distributed server system that hosts the program code. In this aspect, project leaders 3 log into the apparatus 2 through an Internet browser, such as but not limited to Microsoft Explorer, Mozilla Firefox, Apple Safari, Google Chrome, or other Internet browsers. The apparatus 2 has a user interface that enables communication to and from the apparatus 2 and the project leaders 3. Other types of communication between the apparatus 2 and the project leaders 3 includes, but is not limited to, facsimile, paper transfer, mobile phone technology, SMS or text messaging, mobile smartphone application, email and others.

Still referring to FIG. 1, a similar type of communication means takes place between the investors 4 and the apparatus 2. Investors 4 may be one or more of individuals, investment banks, private equity firms, corporations, partnerships, banks, municipalities, government institutions, family offices, hedge funds, small companies, government entities, wealth management companies, hedge funds, pension funds, insurance companies, corporations, wealthy individuals, families, and others. The investors 4 are represented by individual entities depicted by the letters a through z. This depiction is random as each individual investor may be represented by many different means including names, code numbers, etc and may be any number one or greater in quantity and are not limited to the arbitrary representation of 26 letters of the alphabet in FIG. 1.

The communication between the investors 4 and the apparatus 2 takes place primarily electronically but is not limited to electronic communication. The electronic communication means can take place through an Internet enabled connection between the investor's 4 computer and the server that hosts the program code. In this aspect, investors 4 log into the apparatus 2 through an Internet browser such as, but not limited to, Microsoft Explorer, Mozilla Firefox, Apple Safari, Google Chrome, or other Internet browsers. The apparatus 2 has a user interface that enables communication to and from the apparatus 2 and the investors 4. Other types of communication between the apparatus 2 and the project leaders 3 includes but is not limited to: facsimile, paper transfer, mobile phone technology, SMS or text messaging, mobile smartphone application, email and others.

Still referring to FIG. 1, there is communication between investors 4 and project leaders 3. This communication consists of communication through the apparatus 2 as well as direct offline communication as may be necessary in the final stages of closing a financing project.

Still referring to FIG. 1, the apparatus 2 may be configured for usage in many different scenarios including but not limited to: an Internet browser and Internet enabled system, a client-server system, a cloud or software as a service system, and others as may be applicable.

Referring now to FIG. 2, the apparatus 2 contains many sub-modules 5 through 10 which all represent different types of technology that form the basic classification of projects to be financed. Each type of technology that enables a project may or may not have certain differences in the way that the apparatus 2 handles, manages, controls, or analyzes information related to the project. In one aspect, the apparatus 2 is configured to interface with and enable financing of “clean energy” based projects. In this aspect, the apparatus 2 has modules: Wind 5, Solar 6, Geothermal 7, Hydroelectric 8, Biomass 9, and Other technologies 10 which may include, but are not limited to, coal gasification, solar thermal, co-generation, natural gas to electricity, energy storage, batteries, electricity grid efficiency, high voltage DC grid, smart grid, tidal, ocean thermal, and others. Each module has a specific financial analysis template for pre-screening and vetting customized to the specific technology adopted.

Still referring to FIG. 2, the Wind 5 module is invoked when a project leader 3 uploads a project that uses a technology that converts wind energy to another type of energy which is typically but not limited to electrical energy. The Wind 5 module is specifically configured to prompt project leaders 3 for specific information, documents, estimates, financial information, and other information relating to that needed to properly perform pre-screening, vetting, data storage/control, and investor matching for wind technology enabled projects. This information includes, but is not limited to, geographic location, wind speed estimates based on day/time of day, month, etc., licenses, permits, wind generator manufacturer and model number, and altitude of the installation.

Still referring to FIG. 2, the Solar 6 module is invoked when a project leader 3 uploads a project that uses a technology that converts solar energy to another type of energy, which is typically but not limited to electrical energy. The Solar 6 module is specifically configured to prompt project leaders 3 for specific information, documents, estimates, financial information, and other information relating to that needed to properly perform pre-screening, vetting, data storage/control, and investor matching for solar technology enabled projects. This information includes, but is not limited to, geographic location, panel manufacturer and model number, assumed panel efficiency, orientation angle, pitch angle, articulation, number of panels, SRECs, permits, and licenses.

Still referring to FIG. 2, the Geothermal 7 module is invoked when a project leader 3 uploads a project that uses a technology that converts geothermal energy to another type of energy which is typically but not limited to electrical energy. The Geothermal 7 module is specifically configured to prompt project leaders 3 for specific information, documents, estimates, financial information, and other information relating to that needed to properly perform pre-screening, vetting, data storage/control, and investor matching for geothermal technology enabled projects. This information includes, but is not limited to, geographic location, depth of the bore, estimate on the differential temperature, permits, licenses, medium drilled used, and engineering studies.

Still referring to FIG. 2, the Hydroelectric 8 module is invoked when a project leader 3 uploads a project that uses a technology that converts hydroelectric energy to another type of energy which is typically but not limited to electrical energy. The Hydroelectric 8 module is specifically configured to prompt project leaders 3 for specific information, documents, estimates, financial information, and other information relating to that needed to properly perform pre-screening, vetting, data storage/control, and investor matching for hydroelectric technology enabled projects. This information includes, but is not limited to, geographic location, permits, licensing, flow rate, differential height of pressure head, engineering studies, type of plant/generator, manufacturer of plant/generator, and the reservoir size.

Still referring to FIG. 2, the Biomass 9 module is invoked when a project leader 3 uploads a project that uses a technology that converts biomass energy to another type of energy which is typically but not limited to liquid fuels and electricty. The Biomass 9 module is specifically configured to prompt project leaders 3 for specific information, documents, estimates, financial information, and other information relating to that needed to properly perform pre-screening, vetting, data storage/control, and investor matching for biomass technology enabled projects. This information includes, but is not limited to, permits, licenses, type of plant/converter, manufacturer of plant/converter, type of fuel produced, consumers or offtakers of fuel produced, type of feedstock (energy input), and feedstock supply agreements.

Still referring to FIG. 2, the Other 10 module is invoked when a project leader 3 uploads a project that uses a technology that does not fit any of the other sub-categories and provides for expansion of the system beyond the definition of clean energy projects. To those skilled in the art of project finance, the methods and systems within the present method and apparatus apply to any project finance project including, but not limited to, non-energy projects, such as, construction, product development, new technology, equity financing, debt financing, municipal projects, infrastructure improvements, and any other project type that may need financing. Additionally, the Other 10 module may include any of other energy related projects including, but not limited to, fuel cells, landfill gas, low impact hydroelectric, wave/tidal, coal gasification, biofuels, coal, oil, natural gas, offshore oil, offshore natural gas, methane digestion, co generation, nuclear fission, nuclear fusion, solid waste conversion, post industrial waste conversion, solar thermal, ocean thermal, artificial photosynthesis, microbial organism hydrogen gas generation, high voltage DC grid, smart grid, batteries, energy storage, co generation, natural gas to electricity, grid efficiency, and others.

Still referring to FIG. 2, all of the modules: Wind 5, Solar 6, Geothermal 7, Hydroelectric 8, Biomass 9, and Other 10 share common informational elements that the project leader 3 uploads or inputs to the apparatus 2 which includes, but is not limited to: power purchase agreement (PPA), PPA signed or not signed, length of PPA, expected output, tax incentives, expected investors return stated in internal rate of return (IRR), levered IRR, or other financial return metrics as appropriate, financing type (equity, debt, combination), energy off taker (consumer or customer), location of installation including the latitude and longitude, project size, distance to the electrical grid connection point, annual production estimates, annual production estimates, project name, current state of the project, land acquisition rights, right of way agreements, major activities completed to date, major activities to be completed, partners, principals, partner agreements, principals agreements, project cash outflows (capital costs, construction costs, development costs, interconnection (connection to the grid) fees, transmission line fees, permitting fees, environmental studies, and other items), periodic cash outflows (maintenance costs, re-permitting, downtime, planned capital improvements, and others), recurring cash flows (operations and maintenance, land lease payments, property insurance, business insurance, metering, billing, administration, and others), one time cash in flows (feed in tariff, federal incentive, state/provincial incentive, utility incentive, system buyout, and others), key dates (contract signing, permit approval, construction start, construction end, commissioning, and others), and other items.

Referring now to FIG. 3, the process and flow 11 contained within the apparatus 2 comprises several progressive steps and communications to and from the apparatus 2 and project leaders 3 and investors 4. As stated above, project leaders 3 upload certain information related to the project that they wish to have financed. The nature and details of this information is disclosed above in partial terms in sub modules 5 through 10. Additionally, the project leaders 3 upload information to the apparatus 2 relating to the financial details of their project. This, along with the sub module information, provides the basis for the apparatus 2 to perform the pre-screening process 12. More specifically, the pre-screening process 12 includes a financial information query including, but not limited to, project output size, production size, depreciation type and schedule, taxation rate, Federal and State/Provincial incentives, Utility incentives, other incentives, recurring cash inflows, construction costs, development fees, and recurring costs (operation, maintenance, insurance, billing, monitoring, administration, property tax, escalation factors, and other). These inputs provide enough information for the apparatus 2 to perform a financial viability rating in the pre-screening process 12. The output of the financial viability model which is either a discounted or a non-discounted cash flow model is the investment payback (in years), rate of return for investors (typically, but not always, in internal rate of return), and the net present value (NPV) of the project. The results of the financial viability model combined with other metrics from information uploaded as described in the sub modules 5 through 10 complete the information that the apparatus 2 needs to provide a financeability rating for the project typically in several categories. The apparatus 2 automatically drafts a document showing the aspects of the project that provide for ease or difficulty in the financing process and communicates this to the project leader 3. If the project is deemed financeable, the report states this as well as provides instructions for next steps to progress the project towards closing a financing as well as how many potential investors in the apparatus 2 are available and potentially interested. If the project is deemed not financeable, the report states this as well as provides instructions for what aspects of the project need to be improved in order to progress to the next stage for interaction with investors; it also states how many investors may potentially be interested in the project should the project leader 3 improve the deficient aspects of the project in the manner that the report specifies.

Still referring to FIG. 3, if the project passes the pre-screening process 12 and the project leader 3 decides to progress to the next stage, the project enters the vetting process 13. The vetting process 13 is a much more inclusive and detailed analysis of project readiness and project financeability. During this vetting process 13, the project leader 3 continues to input more information relating to the project in primarily, but not limited to, three categories, namely, financial, business, and documents. The financial information forms the basis of a financial vetting tool that is much more comprehensive than the pre-screening financial analysis. Inputs to the vetting process 13 financial analysis include, but are not limited to, price per energy unit, loan term, leverage, expected closing date, fees, carried interest, number of years intended to operate, financial details of any contracts negotiated, start and end years for the contracts, escalation factors for the contracts, recurring cash flows, start and end years for recurring cash flows, escalation factors for recurring cash flows, taxation rates, cash discount rate, capital expense (capex) details (enabling technology, cost of technology, civil works, general works, inverters, wire/electrical, evacuation switchyard, engineering, construction management, initial payment amount and date, final payment amount and date), fees (developers, consultants, general contractor, construction finance, long term debt, tax equity investor, equity investor, administration, operator), production estimates, and others. Those skilled in the art of project finance understand that there may be additional items related to the specific nature and type of the project as well as the technology being utilized by the project. The apparatus 2 automatically generates several reports and sub reports relating to the vetting process 13 financial analysis including but not limited to, automatic updates on solar, wind, etc data from third party central databases to calculate actual output of the presented project, investment timeline, cash flow analysis (discounted and non-discounted), depreciation schedule, leverage, project return (typically IRR or levered IRR), investment return (typically IRR), and others. Additionally, the graphical interface showing the financial data has a feature that shows each variable in a color coded manner indicating where financial values are generally in bounds or out of bounds from normally accepted values. Other coding methods besides color-coding may be presented such as graying, hashing, and other methods. Additionally, at this stage of project funding, typically a due diligence process is initiated. The apparatus 2 provides for a portion of the due diligence to be performed within the financial analysis by a graphical indication of all of the project financial attributes in the financial analysis that typically require some level of due diligence. The system allows only qualified and certified due diligence analysts to interact with the due diligence features of the apparatus 2 in the vetting process 13 financial analysis. The graphical or visual indication allows this due diligence analyst to render any item with a status of not started, in process, complete, or other and can indicate a ranking of risk (numerical value) to each item as well as to input notes, web links, links to documents, etc. validating the nature of the due diligence performed. Inputs to the vetting process 13 business analysis include but are not limited to: project name, project ID, location (including latitude and longitude), primary contact person details, requestor contact details, project readiness items with percentage completed (land/property contract, feedstock agreement, off take agreement, power purchase agreement (PPA), incentives secured, supply chain agreements, general contractor (EPC) agreements/contracts, operations and maintenance contracts, insurance, project development, engineering studies, environmental studies, permits, interconnection contracts, transmission line contracts, external party agreements, utilities agreements, government agreements, completed financial analysis, and others), and others. The apparatus 2 automatically creates a vetting process 13 business analysis with a score and graphical indication in the categories including but not limited to: technology, financial, construction/project management, geo political, operations and maintenance, environmental/regulatory, insurance and risk management, counterparties, and others. The apparatus 2 automatically generates these scores and graphical representations which may be in a number of different formats including but not limited to: shading, hashed, colors, gauges, meters, and others and may be an overall score, a sub categorical score, or a score on a detailed piece of information and any of them can be modified by certified due diligence analysts. The apparatus 2 provides for any modification of these scores to be annotated with notes completed by the due diligence analysts which may include text, web links, document links, and others. Those skilled in the art of project finance will realize that the nature of the project and the technology that the project employs will affect the number and nature of the business items in the vetting process 13. The apparatus 2 automatically creates a data/document management system 21. Project leaders 3 may upload or transfer documents of many different types including but not limited to: project description, project timeline, general site assessment, project location(s) assessment, project site pictures, site selection assessment, fatal flaw report, ownership model (current), ownership model (future), other or third party agreements, business summaries for third or other parties, statements of qualifications for other or third parties, special purpose vehicle (SPV)/special purpose entity (SPE) structure, SPV/SPE ownership and voting rights, SPV/SPE general agreements, articles of incorporation, by laws, operational agreement, shareholder's agreement, joint venture (JV) and partnership agreements, management organizational chart, bios/CVs of management and key personnel, investor CVs, partner CVs, counterparty agreements, buy out agreement, credit reports, legal assessments, liens, title searches, third party project review, third party contract review, copies of past/current/outstanding litigation, copies of past/current/outstanding arbitration, requests for proposal (RFP), RFP public notices, RFP responses, award letters, financial analysis, summary of capital/equity/debt contributed to date, energy projections and yield monitoring, energy market analysis, detailed capex budget, detailed capex schedule, operations and maintenance budgets, operations and maintenance schedule, depreciation schedule, taxes, subsidy review, consulting and third party fees, buy out provisions/agreements, incentive assessments/agreements (FIT, REC, SREC, carbon credits, green certification, etc.), future expansion plans, debt report, government agreements (PPA, land lease, natural resources), tax abatements, power purchase agreement, sale-leaseback agreement, net metering agreement, feed in tariff agreement, energy off taker agreement, land lease/purchase agreement, agreement granting ownership/availability of the area, land right of way agreements, 20 year notarial report of land ownership/availability, interconnection study, interconnection agreement, transmission/distribution study, transmission/distribution agreement, permits and licenses, technology licenses, monitoring/metering/billing agreement, pre engineering design package, third party insolation analysis, engineering study, geotechnical assessment, general engineering studies, detailed engineering studies, engineering drawings, construction drawings, cadastral surveys, construction costs/budget, construction schedule, construction technical assessment, supplier analysis, supplier agreements, equipment availability/schedule, equipment specifications, equipment warranties, construction contracts, engineering procurement and construction (EPC) bids, EPC contracts, EPC warranties, construction gantt chart, surety bond letter, production guarantee, variances, construction permits, construction licenses, operations and maintenance bids, operations and maintenance responses, operations and maintenance contracts, operations and maintenance budget/cost estimates, purchase orders, construction plan, operations plan, project management plan, project management schedule, current state of project development, risk management assessment, general liability insurance, construction insurance, property risk insurance, equipment breakdown insurance, business interruption insurance, production insurance, start up/construction delay insurance, environmental risk insurance, geopolitical risk insurance, local/state/provincial/federal regulations, regulation and policy evaluation (past, current, future), environmental studies, landfill closure report, environmental permits, environmental approvals, public impact analysis, public impact plan, community engagement plan, public notices, public meeting notifications, public meeting requests, public meeting reports, public meeting results, marketing plan, past public announcements/messages, current public announcements/messages, future public announcements/messages, wind studies, geotechnical assessment, bird impact study, noise impact study, off gas report, thermal resource report, thermal resource analysis, third party test well analysis, well water corrosion analysis, drilling bid, drilling contract, drilling warranties, water resource study, and others. Those skilled in the art of project finance and clean energy project finance will appreciate that more items may be added as would be appropriate for the type of project being financed. The apparatus 2 will automatically generate an appropriate list for the type, size, geographic location, and other factors related to the project as an initial list of required documents and will have a place holder in the data/document management system 21. The apparatus will also generate metrics and graphical/visual indications thereof of the completion of the population of the required documents for that project's specific data/document management system 21. Due diligence analysts can add or subtract documents from a project's specific data/document management system 21 and can rank each document numerically which the apparatus 2 uses to calculate overall project readiness metrics. In some cases, the apparatus 2 will have tools for the project leaders 3 to create these documents with inputs using the software system's 2 graphical user interface. The vetting process 13 also generates a risk assessment based on all of the information related to the project which includes but is not limited to the following categories: completion risk, operational risk, revenue risk (volume), revenue risk (price), debt structure risk, engineering risk, technology risk, jurisdictional risk, and/or others. If a project has metrics that are sufficiently high, and/or risk factors that are sufficiently low, it passes to the matching process 14. If not, the apparatus 2 communicates with the project leaders 3 to identify areas of deficiency. This is a continuous process of evaluation by the apparatus 2 as new information is inputted or uploaded by project leaders 3. Alternatively, due diligence analysts may force a project to the matching process 14 even if does not have the sufficient scores to do so automatically.

Still referring to FIG. 3, the matching process 14 starts when a project or projects pass through the vetting process 13. The matching process 14 automatically generates logical pairings between projects and investors 4. Investors 4 create a profile in the apparatus 2 that includes all of their preferences both high level and detailed for what types of projects they are interested in investing in which may trigger from any one or more of criteria, including but not limited to, percentage of key attributes, weighted average, score from a non-linear equation, keywords, document keyword data mining, jurisdictional, technology, IRR range, investment size, developer's reputation, financial deal structure, other investors interested, and others. When projects pass through the vetting process 13 into the matching process 14, they are automatically “linked” to investors 4 who may be interested in investing that particular project. The investors 4 may create their personalized and customized preference for how matched projects are presented by the apparatus 2 to them which may include, but is not limited to, customized metrics, system standard metrics, simple report, comprehensive report, and others. Customized metrics may be created by investors 4 or due diligence analysts. Custom metrics may be different than standard metrics in topic or in weighting of various factors or by a formulation of an algorithm. Investors 4 may elect to receive their project matches singularly or in bulk based on some time interval or by manually pulling them from the system without active notification.

Still referring to FIG. 3, if an investor 4 decides to accept a matched project, it typically means that the investor 4 wishes to receive additional information about the project. This invokes the apparatus 2 to automatically generate a report or a series of reports through the report generator process 15. The apparatus 2 generates minimally one but preferably two or more reports for communication to the investor 4. Typically, these reports generated through the report generator process 15 include an executive overview and an executive summary. The executive overview is typically a one page snap shot view of the opportunity where the executive summary is more comprehensive. The report generator process 15 will generate the report or reports based on one of the investor's report preferences, system standard report preferences, the due diligence analyst's report preferences, or a custom report preferences made by an authorized user or due diligence analyst. In all of the report generation, it can be communicated directly to the investor 4 or it may be first routed to a due diligence analyst for editing. Each of the reports contains a link to the project dashboard in the apparatus 2. The project dashboard is a representation of the project's readiness for financing. The perspective of the metrics may be viewed in system mode (standard settings), due diligence analyst's mode (settings modified by the due diligence analyst), or the investor's 4 mode (settings and metrics modified by the specific investor 4 who is viewing the dashboard). If the investor 4 is interested in pursuing a particular project for investment or additional due diligence, the investor 4 may communicate with the project leader 3. This communication can take place outside or inside of the apparatus 2. If it takes place, even partially, within or through the apparatus 2, all communication and information is logged by type and chronologically for record keeping, regulatory compliance, and for other reasons.

Still referring to FIG. 3, if the investor 4 wishes to document the due diligence steps and information within the apparatus 2, the investor can communicate with the project leader 3 and due diligence analysts with the due diligence/project management system 16. The due diligence/project management system 16 is described in detail under the description for FIG. 4 item project management 26.

Still referring to FIG. 3, those skilled in the art of financing, project financing, project development, project management, or other items relating to projects and financing will realize that the communication flow presented in the foregoing paragraphs is just one example of communication flow and steps in a financing process. The apparatus 2 is flexible to other arrangements and has features so that authorized users can change the steps, order of the steps, add steps as might be appropriate for any particular project. Additionally, any communication type is possible.

Referring now to FIG. 4, the apparatus 2 employs additional technology, capability, and functionality that exist across all sub modules, communications, and information or process flow: user interface 17, matching 18, learning 19, SREC 20, data 21, due diligence 22, compliance 23, project engineering due diligence 24, financial analysis 25, project management 26, commerce 27, and other 28. More specifically, the apparatus 2 has a user interface 17. Like most other web enable appliances, the user interface 17 employs graphic design, pull down menus, search capability, and other standard items found on most web sites. Additionally, the user interface 17 provides for a user login. Only authorized users of the apparatus 2 may access information, communicate with, and interact with it. When an authorized user has completed a login, the authorized user can set his or her customized preferences. These preferences relate to how the authorized user wishes to view information about projects and project data as well as communication preferences, and others. Additionally, the authorized user can authorize the apparatus 2 to accept electronic signatures from that authorized user and has an interface to set up those particular details. The apparatus 2 will also automatically create and communicate an electronic non-disclosure agreement and/or a terms and conditions agreement and/or a non-circumvention agreement that the authorized user can sign electronically using the apparatus 2. Additionally, the apparatus 2 provides various types of dashboard views of project information (both detailed and summary views with and without sensitivity analysis). The authorized user can choose through their preferences what type of dashboard graphical interface they would like to see for project information as well as what level of detail the apparatus 2 will present to them for any particular project. All of these preferences may be set for a particular authorized user and can be customized or changed for a particular project that the authorized user has access to. The apparatus 2 monitors which projects any authorized user has access to; other projects will not be available to that particular authorized user. For example, a project leader 3 typically will only have access to their projects whereas an investor 4 or a due diligence analyst may have access to many or all of the projects as is appropriate for the particular authorized user. Investors 4 complete their profile based on preferences for what type of projects they either are looking for or typically invest in. The apparatus 2 presents a basic questionnaire that relates to high level items such as but not limited to: financial performance targets, jurisdictions, size of investment, technology employed, and others. Additionally, the apparatus also allows the investor 4 to expand the questionnaire and therefore profile to include any or all of the project metrics that the apparatus 2 uses to evaluate projects and allows the investor to input key words that may trigger a particular project to be of interest outside of the standard metrics. Conversely, the investor 4 may choose “show stopping” issues that would automatically decline a project from their consideration. The investor 4 may also choose to list items that they are flexible on and, if they choose, to specify a target range as well as values for metrics that may have dependencies and can list their history of financing deals completed. For instance, an investor 4 may allow a project with a lower than desirable IRR if and only if, the project size is above a certain threshold, can have different IRR thresholds for different jurisdictions/technologies, can enter keywords for matches, and others and that any may be combined or eliminated in a Boolean fashion. It should be understood that any user and not just investors 4 who have multiple project access and the ability to search for projects have the ability to make these preference user profile selections. Additionally, the apparatus 2 allows for a classification of investors that are partners or super-users which provides for a custom user interface, graphical presentation, project presentation, financial calculations, executive overview format, executive summary format, communication preferences, and others.

Still referring to FIG. 4, the apparatus 2 has a matching system 18; this was previously presented in the detailed description for FIG. 3. In addition to the previously presented description, the matching system 18 has additional functionality and flexibility to make investor 4 to project matches. More specifically, the matching system 18 allows users to perform what if analyses which allow them to define a broad range of metrics, ranges for these metrics, risk factors, etc. to query the apparatus 2 for additional matches that may otherwise fall outside the range of their user defined preferences. The matching system 18 employs different matching means or algorithms. In the most simplistic aspect, it will match projects with investors 4 based on a linear model or algorithm. If a project has key attributes or metrics that match to an investor's profile or a certain percentage of them do, then a match is made. In a more complex approach, the matching system 18 uses a weighted average to calculate matches. The weighted average uses system constants and investor 4 profiles to determine the importance or weighting to be placed on any one or more metrics or attributes. In the next most complex approach, the matching system 18 employs a non-linear algorithm to calculate matches. The apparatus 2 typically will use trends and learning algorithms to determine appropriate factors for the non-linear matching algorithm. Additionally, the investor 4 or due diligence analyst can elect to manually force a match between a project and an investor 4. Additionally, the matching system 18 may make a match based on matching key words in the project information versus the key words known to the apparatus 2 related to the investor 4 which may be manually entered by the investor 4 or learned by the apparatus 2. Additionally, the matching system 18 may make a match based on the number of document views an investor may make or number of information types he or she may view in a particular project. The matching system 18 will also employ a feature for logical groupings of investors 4 or investor syndication in which case it presents that a group of investors 4 together may be interested in and would be matched to a particular project; this can be accomplished automatically by the apparatus 2 or can be manually “forced” by the due diligence analyst and will also include a feature to allow different terms and conditions from one investor 4 to other investors 4 in the investor syndication. In order to further improve the capability of investor syndication, the apparatus 2 may employ other technologies through internet linking or API or other methods to third party services that may include, but are not limited to, crowd funding sites/software/services, Master Limited Partnership sites/software/services, financial services type sites/software/services including but not limited to Baird's services and other investment research and data services. The matching system 18 will also employ a feature for logical groupings of projects or project amalgamation that would be matched to a singular or syndicated group of investors 4 which can be done automatically by the apparatus 2 or be manually forced by an authorized user or a due diligence analyst. Additionally, the matching system 18 will have a project combining attribute for projects of different technologies that can be combined into a single use interconnection or power purchase agreement or land lease agreement or other combinations of project attributes including matching of sub-leasing land, interconnection, or power purchase agreements from one project to another on the same site or geographically proximate sites. Additionally, the matching system 18 will have a feature that identifies projects that not passing the gateways of pre-screening or vetting but have many attributes and metrics that are attractive. Typically, the apparatus 2 will communicate these “high potential” rejected projects to due diligence analysts or other users who may help the project leader 3 complete or improve items to move forward to introduction and matching to an investor 4.

Still referring to FIG. 4, the apparatus 2 employs a learning system 19. The learning system 19 records all interaction between the authorized users and the apparatus 2. These interactions can include but are not limited to adjustments/changes in the user profile items, queries, key words, assumption changes, metric changes, text, documents, email, financial analysis assumption changes, document views, document downloads, project views, investments made, and others. The learning system 19 uses this data to suggest changes to individual authorized user profiles, to make more intelligent matches between projects and investors 4. Additionally, the learning system 19 records jurisdictional based information and requirements. As projects come through the apparatus 2, the learning system 19 records items such as permits, licenses, government approvals, and other items that are required. This information is used to more intelligently and automatically populate the document and requirement lists for projects in a particular jurisdiction as well as providing information for the apparatus 2 to create document standards and standard checklists for each technology and jurisdiction.

Still referring to FIG. 4, the apparatus 2 employs an SREC trading system 20. The SREC (solar renewable energy certificate) trading system 20 provides a platform and exchange for the selling, bartering, or trading of SRECs. Any authorized user of the apparatus 2 may interact with the SREC trading system 20. Project leaders 3 may offer SRECs from their projects for sale or for trade. Buyers may make offers above or below the asking price or offer trades for other goods, services, financing, etc. The SREC trading system 20 is integrated with the financial analysis system 25 in that buyers and sellers can see the sensitivity and effect on financial metrics of the project if the project's SRECs are sold at a particular price or range of prices. The SREC trading system 20 may also include trading, bartering, or selling of other credits of any kind whether government-based or not. A typical example of this is the trading, sale, or bartering for carbon credits.

Still referring to FIG. 4, the apparatus 2 employs a data system 21. The data system 21 is the central repository for all data contained in the apparatus 2. Typically the data system 21 at its core is a database of any of the various types of databases currently available on the market or will be on the market in the future. One of the key features of the data system 21 is the data room or project document repository previously discussed in the detailed description for FIG. 3. In addition to the previously presented description, the data system 21 employs many control, view preference, and workflow functions related to the documents in the data room. All of the documents in the data room may be controlled by a state or revision control system. In the most simplistic form, the data system 21 tracks when authorized users make changes to the document and provides a revision number and revision date for each. Authorized users may subscribe to any document that they have access to. If they subscribe to a document, any time a change is made to the subscribed document, the authorized user receives a communication from the apparatus 2 indicating that a change has been made. In a more complex arrangement, the data system 21 can apply controls on individual documents or other items of information or data. These controls assign an authorized user or multiple users who must approve proposed changes to the document or item of information. In this aspect which may work in parallel to the more simplistic aspects 4 and activated for certain documents and not for others, the approval process follows one of two types of workflow routing: approval in series or approval in parallel. Referring to FIG. 6, with parallel approvals 33, the apparatus 2 sends approval requests to all of the approvers simultaneously. Referring to FIG. 5, with series approvals 32, the apparatus 2 sends approval requests sequentially according to the order set forth when the document or information was denoted as one that needs approval for change. In both cases, any approver may delegate their approval to another authorized user of the apparatus 2 and further delegate that it should either be approved by the delegate or should route back to the delegator for final approval. Additionally, the data system 21 denotes documents and other items of information with a status such as approved, completed, archived, in process, out for change, or others. Any of these may carry color-coding or shading or fill designs such as hashing so that the authorized users can easily identify visually the document or other item of information's status. Additionally, the data system 21 allows the authorized user to create a customized view of their documents as well as how they are structured. This allows the authorized user to have their own data structure much like how they would customize their own data structure on their personal computer which may be different than the apparatus 2 standard structure which may also be different from the structure that any other authorized user may decide is best for them. Investors 4 and due diligence analysts and other authorized users may add or delete documents and other information items from the standard list to customize the required list for any particular project. Additionally, analysts and investors 4 may customize the status of the documents or other information types to suit their particular preferences and can request additional documents or delete documents as necessary. Additionally, the data system 21 will have a feature to standardize common document types and will provide this standard format derived from the learning tool in both a template means as well as a standard form in a word processing software such as but not limited to Microsoft Word.

Still referring to FIG. 4, the apparatus 2 employs a due diligence system 22. The due diligence system 22 is active throughout the entire process from when the project leader 3 uploads a project to when it is removed from the apparatus 2. Primarily, the due diligence system 22 monitors and records all communications as discussed previously. Additionally, and as discussed previously, the due diligence system 22 provides for analysts and investors 4 and other authorized users to make notes in the various financial analyses; this feature can be used to validate a particular entry as vetted or confirmed and may contain other items, discussions, links to web sites, links to documents and other information types. Additionally, the due diligence system 22 generates the executive overview and executive summary reports as previously discussed. Additionally, the due diligence system 22 can create an electronic or document report showing all of the communications relating to the project, all notes made, all actions took, etc.; it can present this information in the due diligence report in a chronological format, standard organized format, or a customized organized format, or all of the above. The due diligence system 22 also has a learning system that monitors questions or queries from investors 4. When a certain level of learning about a particular investor 4 or groups of investors 4 is complete, the due diligence system 22 will automatically generate a list of questions for the project leaders 3 and due diligence analysts or other authorized users when a particular project is matched with a particular investor. Additionally, the due diligence system determines risk factors based on key words listed on the investor's 4 profile and through the learning system. Additionally, the due diligence system 22 will automatically highlight key words and phrases in documents and other items of information in the data system 21. The key words and phrases that it highlights are those from matched investor's 4 profiles as well as system standard key words and phrases as well as additional key words and phrases inputted by analysts and other authorized users. This helps the investors 4 and analysts to quickly and easily find the items of interest in what are typically very long documents. Additionally, any authorized user can upload additional information relevant to due diligence and due diligence record keeping such as emails, CRM historical data, phone records, or other items as necessary. Additionally, investors 4 and other authorized users may elect to place the project into full due diligence mode. If this is done, that authorized user can add items that need to be completed in order to denote the project as due diligence complete. This, as with the other items in the due diligence system 22 are integrated with the project management system 26 as discussed and described below.

Still referring to FIG. 4, the apparatus 2 employs a compliance system 23. The compliance system 23 is an integration between the apparatus 2 and the compliance needs related to various activities that users of the apparatus 2 may be performing. One such compliance need is if the users of the apparatus 2 are also conducting business activity as or are partnered with a broker, or broker dealer for the completion of financings. In this case, there are compliance needs with FINRA (Financial Industry Regulatory Authority of the United States of America). There may be other industry and regulatory board needs in the United States of America or in other countries. The integration between these systems may be electronic such as through and API (application programming interface) or by other means such as by paper or electronic reports.

Still referring to FIG. 4, the apparatus 2 employs a project engineering due diligence system 24. The project engineering due diligence system 24 has functionality similar in function to the due diligence system 22 but the individual items are customized to look at the upfront engineering and related documents of the project whereas the due diligence system 22 relates more to financial and business matters. The project engineering due diligence system 24 may integrate to third party offerings with or without the aid of an API to or from the apparatus 2.

Still referring to FIG. 4, the apparatus 2 employs a financial analysis system 25. Many items, features, and functionality contained within the financial analysis system 25 has already been discussed and described in relation to the pre-screening process and the vetting process. Additional to the above presented discussion, the financial analysis system 25 has a user interface that helps project leaders 3 to input information in addition to a spreadsheet standard template and uploader for both the pre-screening and vetting financial analyses. The uploader allows a project leader 3 or other authorized user to complete a spreadsheet such as Microsoft excel (presented and communicated to them with a standard template) and then once this is completed with the project's financial information, the apparatus 2 receives the spreadsheet and automatically populates the information in the financial analysis system 25. Similarly, the financial analysis system 25 can export the analysis to a spreadsheet for offline viewing and manipulation. Additionally, the financial analysis system 25 provides authorized user with summary reports, detailed reports and a color-coded schema on individual items or groups of items as to the level of completion of the analysis. Additionally, the financial analysis system can automatically query standard databases on important information such as wind speed, solar radiation, and others as is appropriate for the particular technology associated with the project. Additionally, the financial analysis system 25 includes tools for authorized users, investors, and due diligence analysts so that they can perform “what if” studies in order to understand what changes a project might need to advance to a higher state of investor readiness or fundability. Additionally, the financial analysis system 25 tracks changes made to the financial analysis and logs these changes as well as which authorized user made the changes. Older versions of the financial analysis are archived and may be recalled by authorized users. Additionally, financial analyses may be deemed as revision controlled documents or as change controlled documents and will be treated as other types of information or documents denoted as such in the data system 21. Additionally, the financial analysis system 25 tracks changes made to changed assumptions and learns these; the apparatus 2 then presents these findings to authorized users who have access and authority to make changes to the base templates of the financial analyses, assumptions, and other items. Additionally, the financial analysis system 25 provides reports on industry and financial industry standard metrics and or ratios and other items.

Still referring to FIG. 4, the apparatus 2 employs a project management system 26. The project management system 26 has been previously described in foregoing sections in partial formats; it handles all of the routing display and control of information, data, documents, and other information types contained in the apparatus 2. More specifically, the project management system 26 employs a project task list. The project task list is an organized task list system that may be invoked by authorized users for any project activity they wish whether this is a project that is seeking funding or other projects. Additionally, the project management system employs a project issues list. The project issues list is an organized system for harboring, controlling, and displaying any issues that arise during the project. Issues typically are related to problems associated with completing a task or more than one task and that require some level of extra attention so as to be completed in a timely manner. Additionally, and referring to FIG. 7, the project management system 26 employs a request for information module 34. The request for information module routes information requests from any authorized user to specific authorized users who are assigned to a particular topic or aspect of a particular project. This enables the efficient flow of the request to the most appropriate and authorized person to handle the information request. Additionally, the project management system 26 employs notepad functionality. The notepad feature allows any authorized user to make personal (private) or public notations on any document or other information type. The notepad also allows the note taker to classify his/her notes in various different categories such as but not limited to: due diligence, general review, approval, and others and allows the note taker to specify whether the note is to be personal (viewed only by the note taker) or public (viewable by all authorized users) or group public (viewable by authorized users within a specific group such as but not limited to a due diligence team or internal team or investor team). Additionally, the project management system 26 employs a collaboration center. The collaboration center is functionality that allows a sub project team or the entire project team to view all of the pertinent information about a specific topic in a summarized view. Typically, an authorized user or group of authorized users would invoke the collaboration center when a particular task or issue is not being resolved in a timely manner but could be used for any purpose. The collaboration center specifies a collaboration leader, name of the collaboration, status of the collaboration, status or synopsis brief status statement, top six actions being taken (if appropriate) with related statuses and due dates, links to information in the apparatus 2, and others. Additionally, the project management system 26 allows the project information to be configured such that all project information items have a named owner who is also an authorized user. Additionally, the project management system 26 has a project timeline feature. The project timeline feature allows authorized users to generate and create project timelines sometimes but not always referred to as Gantt charts. The project timeline feature employs functionality to either allow the authorized user to create a timeline from within the apparatus 2 or by uploading or communicating a timeline created in another software such as but not limited to Microsoft Project. Additionally, the project management system 26 has a project preferences feature. The project preferences feature allows a project leader 3 or other authorized user designated as the project manager or other title to configure a project with items including but not limited to: team members, access of team members, information owners, information access by named authorized user, view and user interface settings, request for information category designates, roles and responsibilities, and others. Additionally, the project management system 26 employs a request for change system that has been previously described in foregoing descriptions. This request for change can be invoked for any information type in the apparatus 2.

Additionally, the project management system employs a request for review system. Referring to FIGS. 8 and 9, the request for review system works functionally like the request for change system in that it has a parallel 35 or series 36 routing arrangement but differs from the request for change system in that the review requestor may designate any authorized users as recipients of the request for review which typically includes at least the information owner of that information item as the apparatus 2 presents this owner as the first recipient though the requestor may delete this authorized user if he/she wishes; additionally, it differs from the request for change system in that all responses are routed to the requestor and optionally all of the reviewers and does not cause a status change or revision change of a particular information item. Sometimes this would be used for “pre approval” of a proposed change or a work in process prior to a formal change request. Additionally, the project management system employs a time sensitivity feature. The time sensitivity feature allows authorized users to put expiration dates on any information item in the apparatus 2. Typically this is used for information items that may expire such as government agreements, licenses, or other contracts. The time sensitivity feature provides warnings to authorized users that an information item may be expiring soon so as to invoke action to resolve the potential problem. Additionally, the project management system has a linking feature. The linking feature allows authorized users to link any information item to any other information item. One such use is to link a timeline item to a project task or series of task then, in turn, link that task or series of tasks to an project issue then, in turn, link that issue to a project collaboration. Another such use is to link a note to a document and/or a specific section or paragraph of the document such as would be typical during due diligence. Links may also be to outside sources such as but not limited to web site references. When a link is made, any authorized user who has access to that information item may click on the link interface that the apparatus 2 creates when a link is made, this routes the authorized user directly to the link without any intervening steps or search difficulties. Additionally, the project management system employs smart email technology. Smart email technology is an email-based communication created by the apparatus 2 and sent to an appropriate authorized user. The smart email is one in which the apparatus 2 is asking for an action to be performed by the recipient which may include but is not limited to: change approval, information request, review request, meeting request, update request, and others. Contained within the body (text portion) of the email are one or more areas to choose an answer or to make an action to the question or action associated to the smart email. These may be links or buttons or other indications. When the recipient clicks these indications, it launches an email that is appropriated coded for the selected answer/action and is addressed to the software system. When the email is sent from the recipient and subsequently received by the apparatus 2, the apparatus 2 will make the appropriate changes in areas such as document change control revision, information request or any other action that was requested by the smart email. Additionally, the project management system 26 includes a time management system. The time management system allows any authorized user to automatically or manually track the time spent on a project or sub items of a project as previously presented. The time management system can also track elapsed time for individual stages of the project as defined by the apparatus 2 or by an authorized user which typically would be a due diligence analyst. Additionally, the project management system 26 includes functionality so that the project leaders 3 or other authorized users can use it for the construction phase of the project implementation. Additionally, the project management system 26 includes a prediction system that informs due diligence analysts as to when they should make a communication with either a developer 3 or a an investor 4. The project management system 26 provides appropriate templates to initiate a financing project or a construction project, and can be used for any project management topic or purpose needed by authorized users such as but not limited to: finance, construction, energy, development, technology development, and others.

Still referring to FIG. 4, the apparatus 2 employs a commerce system 27. The commerce system 27 provides for electronic payments, credit card payments, bank transfers, and other means of routing funds for a variety of reasons including but not limited to: financing fees, due diligence fees, subscription fees, submission fees, software maintenance fees, monthly fees, financing disbursements, and others.

Still referring to FIG. 4, the apparatus 2 employs an other system 28. The other system 28 handles additionally functionality and features not previously discussed and typically not part of any type of discreet module. More specifically, these functionalities and features include but are not limited to: a foreign language component and translator, foreign currency component and converter, applications for mobile phones or smart phones, a crowd funding application, a newsletter for project leaders 3, an industry trends newsletter, data mining on completed deals to learn what features make a fundable project, a customized guide for fundability based on project type/technology/geography/etc., time accounting for project leaders 3 (manual entry type, automatic logging type, metrics/reporting, smart emails for approval of logged time), time accounting for investors 4 (manual entry type, automatic logging type, metrics/reporting, smart emails for approval of logged time), time accounting for analysts (manual entry type, automatic logging type, metrics/reporting, smart emails for approval of logged time), history of deals (both successful and not successful with metrics and reporting), and others. Additionally, the other system 28 includes a social media system. The social media system provides data mining on social media sites such as but not limited to: LinkedIn, Facebook, and others. The social media system automatically searches for projects, investors, and other potential users or customers of interest and then communicates them to specified authorized users with a viability ranking which indicates how attractive that particular opportunity may or may not be. Additionally, the other system 28 includes a specialized interface for Investment Bankers. This specialized interface is customized to the Investment Bank culture and needs and provides for Investment Bankers to join the apparatus 2 as authorized users who will search for investors 4 for their projects and other investment needs as well as will provide for them to refer projects into the apparatus 2 that they are not able to or wish not to work on themselves. Additionally, the other system 28 will provide for multiple classifications of investors 4 such that the higher levels provide for preferential treatment in the matching process.

Still referring to FIG. 4, the apparatus 2 employs a development funding system 29. The development funding system 29 works similarly to all of the other systems that make up the overall project financing activities within and outside of the apparatus 2 but is specifically formatted and configured within the apparatus 2 for projects that are not construction ready and are searching for investors willing to invest in the development phase of the project which typically involves engineering activities and studies and the like. The development funding system 2 includes a feature of data mining all of the projects contained in the overall apparatus 2 and utilizes an algorithm and/or a learning algorithm to identify projects that are candidates for entering into the development funding system 29.

Still referring to FIG. 4, the apparatus 2 employs an Education module 30. The Education module 30 provides authorized users with information about project financing including but not limited to: information on all of the different technologies to invest in, information about what makes a fundable project, information on deals that are getting financed and why, information about jurisdictional or tax sensitivities, the current summarized investment preferences subdivided by many attributes of the investors 4 in the system, and others. The Education module 30 will present this information to authorized users in a variety of ways including but not limited to: newsletters (online and in print), email newsletters, dashboards, summaries, interactive web pages, email attachments, and other means.

Still referring to FIG. 4, the apparatus 2 includes an API module 31. The API module 31 controls linkages to and from third party software, websites, and data services. The API module 31 will control linkages to but not limited to the following: data/document management, broker dealer software, customer relationship management software, email programs, crowd funding sites and software, social media sites and software, master limited partnership sites software and data services, marketing data services, technical data services, environmental data services, and others.

While the foregoing written description of the method and device for facilitating financing for products enables one of ordinary skill to make and use what is considered presently to be the best mode thereof, those of ordinary skill will understand and appreciate the existence of variations, combinations, and equivalents of the specific aspects, method, and examples herein. The method and apparatus should therefore not be limited by the above described aspects, method, and examples, but by all aspects and methods within the scope and spirit of the invention.

What is claimed:

1. A computer implemented method for facilitating financing of projects comprising:
inputting project data into a computer;
prescreening the project data, using the computer, to meet predetermined minimum project standards;
vetting the project data using the computer for project data meeting the predetermined minimum project for financial acceptance;
inputting investor project financing preferences into the computer;
matching the vetted project data with the investor preferences using the computer; and
sending notifications to one or more of the investors and project leaders indicating a match.

2. The method of claim 1 wherein the projects are clean energy projects.

3. The method of claim 1 wherein the projects are construction ready.

4. The method of claim 1 wherein the projects are development projects.

5. The method of claim 1 wherein the pre-screening is based on one or more of financial analysis, project stage, number of agreements completed.

6. The method of claim 1 wherein the vetting includes one or more of financial analysis, document verification, agreement verification, licensing verification, contract verification.

7. The method of claim 6 wherein the financial analysis is a cash flow analysis calculating one or more of levered internal rate of return, unlevered internal rate of return, investor's payback, and net present value.

8. The method of claim 7 wherein the financial analysis is a custom financial analysis for one or more of project technology, project geographical area, project jurisdictional area.

9. The method of claim 7 wherein the financial analysis includes a “what if” function allowing users of the apparatus to perform adjustments to the project financial analysis without changing the saved version of the financial analysis.

10. The method of claim 1 wherein the matching process is based on one or more of investor's preferences, jurisdiction, geography, financial performance projection, technology, developer reputation, size of the investment, show stoppers, key attributes, deal structure, other investor's interest in the project, document key words, key words, and is analyzed in one or more ways, percentage of attributes, average, weighted average, linear analysis, non linear analysis.

11. The method of claim 10 wherein investor matches include combinations or syndications of more than one investor.

12. The method of claim 10 wherein project matches include combinations of more than one project.

13. The method of claim 10 further comprising:
automatically generating one or more of: an executive summary, and an executive overview.

14. The method of claim 13 wherein one of the executive summary and the executive overview can be customized.

15. The method of claim 10 further comprising:
displaying a summary or dashboard view of the project in one or more of investor's preferences for data shown and display type, analyst's preferences for data shown and display type, system standard for data shown and display type.

16. The method of claim 10 further comprising:
manually forcing the matches.

17. The method of claim 10 further comprising:
providing the financial analysis with a “what if” function allowing users of the apparatus to perform adjustments to the project financial analysis without changing the saved version of the financial analysis.

18. The method of claim 1 further comprising:
performing due diligence including one or more of recording all data related to a project, controlling all data related to a project, recording all data related to the financing of a project, controlling all data related to the financing of a project, recording all communications related to the financing of a project.

19. The method of claim 18 wherein the recording of data is done in a manner compliant with government financial regulation.

20. An apparatus for facilitating a process to financially fund a project comprising:
a computer;
a memory containing program instructions; and
the computer executing the program instructions.
inputting project data into a computer;
prescreening the project data, using the computer, to meet predetermined minimum project standards;
vetting the project data using the computer for project data meeting the predetermined minimum project for financial acceptance;
inputting investor project financing preferences into the computer;
matching the vetted project data with the investor preferences using the computer; and
sending notifications to one or more of the investors and project leaders indicating a match.

21. The apparatus of claim 20 wherein the apparatus highlights one of key words, key phrases in any data item related to the project.

22. The apparatus of claim 20 wherein the apparatus provides for linking of any two data items to show one or more of dependencies, relations, source information, the linking providing users of the apparatus the ability to easily navigate from one linked data item to the other directly with a single step, and with the ability to attach a note to the linking of one or more of a private note, a public note, and a group private note.

23. The apparatus of claim 20 wherein the apparatus includes a learning system that records and reports trends relating to one or more of investor profiles, project profiles, industry trends, technology trends, documents required, contracts required, agreements required, jurisdictionally related items, tax and tax credit trends, and standard checklists.

24. The apparatus of claim 23 wherein the learning system suggests standard document formats for project data items.

25. The apparatus of claim 20 wherein the apparatus includes a renewable energy credit trading platform.

26. The apparatus of claim 25 wherein the renewable energy credit trading platform includes integration to the financial analysis to show the affect on the financial performance of the project.

27. The apparatus of claim 20 wherein the apparatus includes a data management system which includes one or more of document repository, access control, revision control, state control, database, view preferences and check in/check out capability.

28. The apparatus of claim 27 wherein the data management system includes the capability of customized data structures for each individual user.

29. The apparatus of claim 27 wherein the apparatus presents a standard document list for each type of project or jurisdiction, with the ability for this standard document list to be customized.

30. The apparatus of claim 20 wherein the apparatus is accessed by authorized users with specific login identification.

31. The apparatus of claim 30 wherein an authorized user can customize the graphical look and feel and the specific content for each project they have access to.

32. The apparatus of claim 20 wherein the apparatus includes the ability for authorized users to add notes to any data item where the note is one of a private note, public note, or group private note.

33. The apparatus of claim 32 wherein the note can be linked to any data item.

34. The apparatus of claim 33 wherein the note can be further linked to a specific area or section inside the linked data item.

35. The apparatus of claim 20 wherein the apparatus includes an application programming interface which allows organized data flow in, data flow out, or control of one or more of other software systems: customer relationship management, data management, data repository, email, financial systems, crowd funding, and social media.

36. The apparatus of claim 20 wherein the apparatus includes a project management system with one or more of: task list, issue list, timeline.

37. The apparatus of claim 36 wherein the project management system has a time sensitivity feature that sends a warning when an project data item is going to expire.

38. The apparatus of claim 36 wherein the project management system includes a time accounting feature.

39. The apparatus of claim 20 wherein the apparatus has the means of receiving electronic payments.
